(19) United States
(12) Patent Application Publication
(10) Pub. No.: US 2005/0178236 A1
(43) Pub. Date: Aug. 18, 2005

(54) Fastening inserts for cycle parts and especially pedal crank and crank gear parts

(75) Inventors: Raymond Crozet, St. Etienne (FR); Michel Jaligot, Saint Chamond (FR)

Correspondence Address: HESLIN ROTHENBERG FARLEY & MESITI PC, 5 COLUMBIA CIRCLE, ALBANY, NY, 12203, US

(73) Assignee: STRONGLIGHT SA, St. Etienne (FR)

(21) Appl. No.: 11/054,198

(22) Filed: Feb. 9, 2005

(30) Foreign Application Priority Data
Feb. 18, 2004 (FR) 0401694

(51) Int. Cl. G05G 1/14

(52) U.S. Cl. 74/594.1

(57) ABSTRACT

A fastening insert for cycle parts and especially pedal crank and crank gear parts, is composed of two parts, namely a lower insert and an upper insert, which are arranged to be joined together and fixedly connected by a mechanical connection. The lower and upper inserts each has flange bearing against a respective opposing face of the receiving cycle part, especially of the crank type.

The invention relates to the technical field of the cycle and its components.

The inserts which are currently used for cycle parts and, in particular, for pedal cranks for the fastening of pedal blanks and/or pedals, are realized in one piece and integrated and embedded in the molding of the crank when the latter is made of plastic, of carbon and of composite materials. The insert can also be added and fastened by gluing. For this purpose, the insert has a flange on its front face which comes to bear upon the opposing face of the crank. This realization currently used by constructors has certain drawbacks, however, especially in the holding and connection of the insert in the crank. Depending on the chosen glue, there may indeed be situations relating to separation of the insert and risk of loss of the crank.

The approach of the Applicant has therefore been to improve the securement of the assembly of the insert in the crank. Secondly, the Applicant has attempted to facilitate the assembly and/or disassembly of the insert in the crank, while maximally securing the insert-crank connection.

According to a first characteristic of the invention, the fastening insert for cycle parts and especially pedal crank and crank gear parts is distinguished by the fact that it is composed of two parts, having a lower insert and an upper insert, which are arranged to be joined together and fixedly connected by a mechanical connection, each lower and upper insert having a bearing flange against the opposing face of the receiving cycle part, especially of the crank type.

According to another characteristic, the insert comprises two parts defining a lower insert and an upper insert, which are arranged with complementary shapes so as to be fixedly connected by force fit.

According to another characteristic, the insert comprises two parts defining a lower insert and an upper insert, which are arranged with complementary shapes so as to be fixedly connected by screwing with the aid of a hand tool and allowing them to be brought closer together and locked in position relative to the receiving cavity or cavities in the crank.

According to another characteristic, the insert comprises two parts defining a lower insert and an upper insert, which are arranged with complementary shapes so as to be fixedly connected by screwing, according to a thread pitch established in one direction, and wherein the upper insert is arranged on a complementary basis with a complementary threaded part with screw pitch and thread reversed relative to the previous one in order to receive the threaded free end of a hand tool for the assembly or disassembly of the insert in its entirety.

The characteristics such as defined and specified in the remainder of the description respond to the drawbacks of the prior art by proposing a new design solution of inserts according to different embodiments, based on two objectives: securement in the insert-crank connection, facility for assembly of the constituent parts of the insert with a short and dependable assembly and/or disassembly time.

These characteristics, and others besides, will become clearly apparent from the remainder of the description.

In order to define the subject of the invention, illustrated in a non-limiting manner in the figures of the drawings, in which:

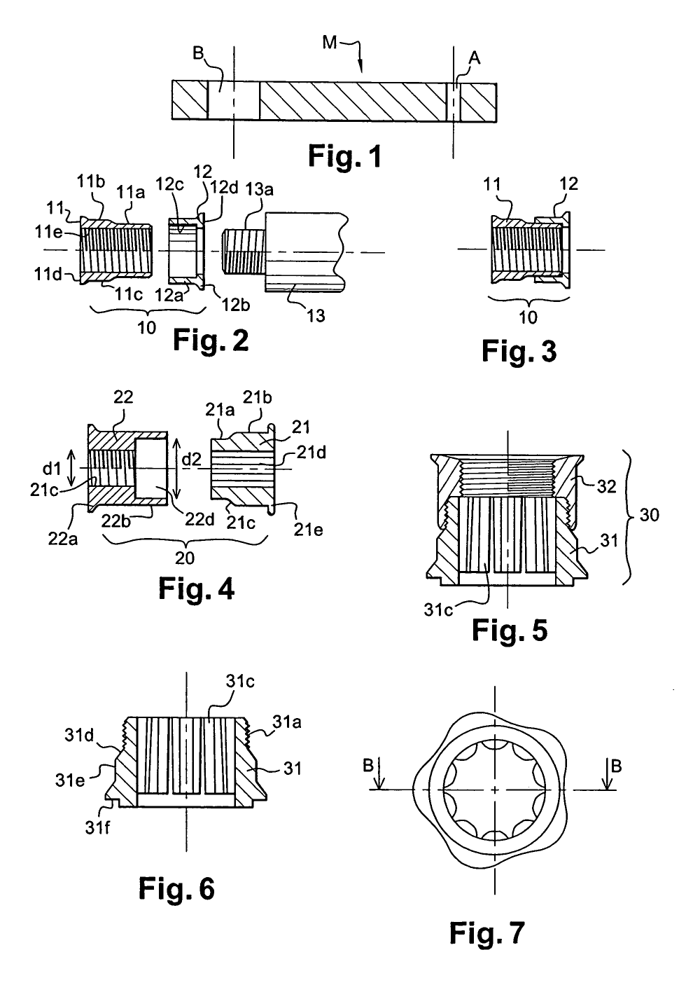

FIG. 1 is a view of a pedal crank for cycles within the framework of one application of the invention, showing the receptacle for the insert in the pedal shaft and the receptacle for the insert in the drive shaft of the crank gear.

FIG. 2 is a view in longitudinal section of a first realization of the insert according to the invention, represented prior to assembly for the pedal shaft.

FIG. 3 is a view according to FIG. 2 of the insert following assembly.

FIG. 4 is a view representing the insert for the pedal drive shaft on a pedal crank according to a first embodiment.

FIG. 5 is a view in a second embodiment of the insert for the pedal drive shaft following assembly of the two bearing surfaces constituting the upper insert and the lower insert.

FIG. 6 is a sectional view along the line BB of FIG. 7 of just the lower insert according to the first variant.

FIG. 7 is a front view of the aggregate according to FIG. 5.

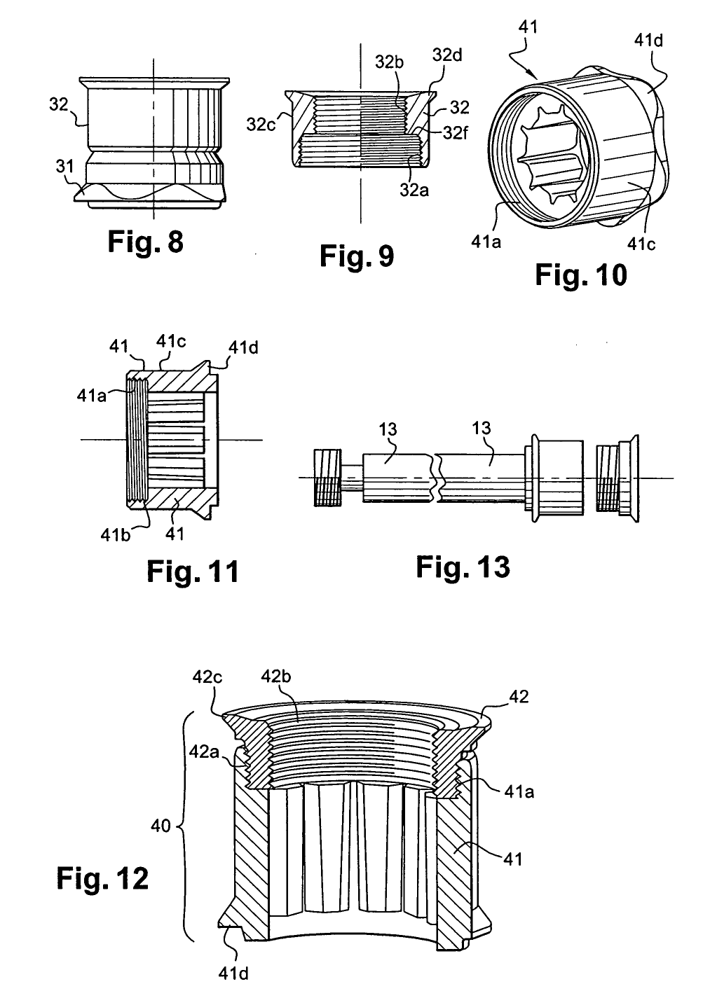

FIG. 8 is a profile view of the aggregate assembled according to FIG. 5.

FIG. 9 is a sectional view of just the upper insert.

FIG. 10 is a view of a third construction variant of the lower insert for the pedal drive shaft, according to the invention.

FIG. 11 is a view in longitudinal section of the lower insert according to FIG. 10.

FIG. 12 illustrates the insert, taken as a whole, according to the third variant in the application for the pedal drive shaft.

FIG. 13 illustrates the clamping and gripping tool of the upper insert in the lower insert of the aforesaid second and third variants, the tool being represented in two halves prior to assembly and in the course of use.

In order to concretize the subject of the invention, it is now described in a non-limiting manner which is illustrated in the figures of the drawings.

According to the invention, the two-part insert for cycle parts is advantageously applicable to pedal cranks (M) and in the remainder of the description reference will be made to this application. However, the invention can be applicable to all other connections which are usable on cycle parts and include two-part inserts.

According to the invention, the insert, taken as a whole, is referenced by (10, 20, 30, 40). According to the four variants described for the fastening of pedal shafts and of pedal drive shafts, the insert comprises two parts designated lower insert (11, 21, 31, 41) and upper insert (12, 22, 32, 42), which are intended to be coupled and fixedly connected by a mechanical connection.

In the remainder of the description, a description will successively be provided of the four variants conceived from the same basic concept of a two-part insert.

Reference is made to the first variant illustrated in FIGS. 2 and 3 in the application to the realization of an insert (10) for a pedal shaft. The insert (10) thus comprises a lower insert (11) and an upper insert (12). The lower insert (11) comprises two successive cylindrical boaring surfaces (11a-11b) of different diameter and defining between them a stop zone (11e), the bearing surface of large diameter being extended by a flange (11d) capable of coming to bear upon the opposing face of the crank. Internally, the lower insert has a female thread (11c) over the whole of its length. The upper insert (12) has a cylindrical outer bearing surface (12a), followed by a counter-bearing flange (12b) bearing on the opposing face of the crank. Internally, the upper insert has a smooth bore (12c) and, on the flange side, a stop-forming constriction (12d). Thus, the upper insert slips for sliding onto the receiving bearing surface (11a) of the lower insert. The installation of the insert in the corresponding receptacle (A) in the crank is effected as follows: insertion of the lower insert and penetration of the upper insert into the receptacle, use of a threaded-ended tool (13), which threaded end (13a) is engaged on the upper insert side so as to fit into the female thread of the lower insert, bringing about the installation of the upper insert to the point where it butts against the parts (12d) and (11c) respectively. In this situation, the flanges formed on the lower and upper inserts engage firmly in bearing contact upon the opposing faces of the crank.

Reference is now made to the second variant illustrated in FIG. 4 in the application to the realization of a two-part insert for a pedal drive shaft.

The insert is referenced in its entirety by (20) and includes a lower insert (21) and an upper insert (22).

The insert (21) is provided internally with grooves, squares, cones or similar (21d) cooperating with said drive shaft, arranged in a complementary manner to provide for the connection and fastening. The lower insert (21) has on its outer periphery two successive bearing surfaces (21a-21b) of decreasing diameter, with a shoulder (21c) and a flange (21e). The bearing surface (21b) of large diameter is situated on the entry side of the insert and is fixed in the corresponding receptacle in the crank by being fixedly connected by gluing. The other bearing surface (21b) allows the reception of an upper insert (22), which is capable of being engaged by the other side of the crank. This upper insert has a bearing flange (22a) bearing on the opposing face of the crank, a smooth outer bearing surface (22b) and, internally, a female thread (22c) of diameter (d1) and a following bore (22d) of larger diameter (d2) capable of engaging on the bearing surface (21b) of the insert. The connection of the upper and lower inserts is effected by force fit one upon the other.

The third and fourth embodiments of the invention will now expediently be described in their application to the realization of a two-part insert for a pedal drive shaft.

According to the invention, the insert is referenced in its entirety by (30-40) and comprises a lower insert (31-41) and an upper insert (32-42). The positioning of the inserts one relative to the other being effected by a rapid assembly or disassembly action using a hand tool (13) specific to the invention. The invention is realized by the provision of the lower insert (31-41) with a threaded bearing surface (31a-41a), which cooperates with a first threaded bearing surface (32a-42a) established on the upper insert according to a first pitch with screw thread in one direction, whereas said upper insert has a second bearing surface (42b) according to a second pitch with thread directionally reversed relative to the previous one. The lower insert (31-41) or the upper insert (32-42) has a peripheral zone (31b-41c) of long length capable of being glued for fastening and fixed connection to the body of the crank (M). The hand tool (13) has a sleeve with a threaded end (13a) capable of engaging in the upper insert on its second bearing surface (32b-42b) to provide for the screwing of the upper insert and its unscrewing relative to the lower insert.

According to the invention, two embodiments of the insert are possible, corresponding to the third and fourth variants, reference being made to FIGS. 5 to 9 for the first and 10 to 12 for the second.

According to the third variant, the lower insert (31) has in a known manner and internally a notching, square, cone or similar (31c) to provide for the installation and driving of the pedal shaft (not represented). The insert (31) has its threaded bearing surface (31a) in the form of an outer periphery, said bearing surface being established on only a part of the length of the lower insert with a stop face (31d) and an adjacent peripheral bearing surface (31c), coming up to the front end of the insert with a bearing flange (31f). The bearing surface (31a) is established according to a screw pitch with thread in one direction. The upper insert (32) is in this case arranged with at its front end with a bearing flange (32d) bearing on the opposing face of the crank and a peripheral outer bearing surface (32c) of long length and constituting a gluing surface. Internally, the upper insert comprises two tapped threaded bearing surfaces (32a-32b) of different diameter, thus delimiting a stop shoulder (32f). The first threaded or tapped bearing surface (32a) of large diameter is located on the back of the upper insert and has a pitch such that fitting on the bearing surface (31a) of the lower insert is possible. The second threaded or tapped bearing surface (32b) of the upper insert is therefore located on the front side of the upper insert and has a screw pitch with reversed thread relative to the previous one. This bearing surface (32b) is capable of receiving, in rapid assembly and disassembly, the threaded end of the hand tool (13). Thus, the assembly of the aggregate is effected as follows. The lower insert is disposed in advance in its receptacle provided for this purpose in the crank. The user positions the hand tool in the upper insert (32) according to a first direction of reverse-threaded screw pitch, then, as a consequence of its securement, said upper insert is then screwed onto the lower insert according to the other screw pitch in the reverse direction. A perfect clamping of the aggregate is thus obtained. The upper insert being pre-glued or the receptacle being pre-glued, the final connection is obtained and there is no risk of mutual separation of the inserts, which are locked together. If need be, provision may be made for the removal of complementary glue-type adhesive substances from the bearing surface (31a) of the lower insert and/or from the bearing surface contiguous to its front face. The removal of the tool is effected by a reverse maneuver of the latter, thereby allowing the removal of the thus constituted insert.

In the fourth variant represented in FIGS. 10 to 12, the lower insert (41) is of longer length and still internally comprises notches, squares, cones or similar for connecting with and driving the pedal shaft. Said lower insert comprises a threaded bearing surface cooperating with the upper insert (42), which is this time on the inside, that is to say revealing a female thread (41a) according to a first screw pitch in one direction. This female thread is established from the rear face of the lower insert over a short length of the insert with a stop shoulder (41b). Externally, the lower insert has a smooth peripheral face (41c) of long length, allowing gluing. In this configuration, the upper insert (42) fixedly connected to the lower insert comprises a first threaded bearing surface (42a), which is established on its outer periphery so as to cooperate with the tapped part (41a) of the lower insert according to a corresponding thread pitch. The upper insert next has a second bearing surface (42b), which is in fact tapped internally according to another pitch and reverse-direction thread for the reception of the tool (13). The insert also has a bearing flange (42c). The assembly method remains the same as that indicated previously.

For this fourth realization, therefore, the same effects as those of the first variant are obtained. For the third and fourth variants, and subject to an interest in disassembling the insert (30-40) thus constituted, it would be sufficient to perform a partial heating operation for the receiving zone of the insert in order to liquefy the bonding glue and then allow the rapid disassembly of the corresponding insert with the aid of the tool (13).

The advantages are clearly apparent from the invention. Particular attention is drawn to the new design of the two-part insert and the particular originality of the choice of a mechanical connection of the components, with the result that assembly and/or disassembly is very simple. This also allows the connection of the lower and upper inserts to be rigidified with an appropriate gripping force.

1. A fastening insert for cycle parts and especially pedal crank and crank gear parts, comprising a lower insert and an upper insert, which are arranged to be joined together and fixedly connected by a mechanical connection, the lower insert and upper insert each having a flange bearing against a respective opposing face of a receiving cycle part.

2. The fastening insert as claimed in claim 1, wherein said lower insert and a upper insert are arranged with complementary shapes so as to be fixedly connected by force fit.

3. The fastening insert as claimed in claim 1, wherein said lower insert and upper insert are arranged with complementary shapes so as to be fixedly connected by screwing with aid of a hand tool allowing them to be brought closer together and locked in position relative to a receiving cavity or cavities of the receiving cycle part.

4. The fastening insert as claimed in claim 1, wherein said lower insert and upper insert are arranged with complementary shapes so as to be fixedly connected by screwing, according to a first thread pitch established in one direction, and wherein the upper insert is arranged on a complementary basis with a complementary threaded part with screw pitch and thread reversed relative to the first thread pitch in order to receive a threaded free end of a hand tool for assembly or disassembly of the fastening insert in its entirety.

5. The fastening insert as claimed in claim 3, wherein the lower insert comprises two successive cylindrical bearing surfaces of different external diameters and defining between them a stop zone, a bearing surface of larger external diameter of said bearing surfaces being extended by a flange capable of coming to bear upon a first face of the receiving cycle part, and wherein, internally, the lower insert has a female thread over a whole of its length, and wherein the upper insert has a cylindrical outer bearing surface, followed by a counter-bearing flange bearing on an opposite face of the receiving cycle part, and wherein, internally, the upper insert has a smooth bore and, on a flange side, a stop-forming constriction, and wherein the upper insert slips for sliding onto a receiving bearing surface of the lower insert under action of the tool.

6. The fastening insert as claimed in claim 2, wherein the lower insert has on its outer periphery two successive bearing surfaces of different external diameters, with a shoulder therebetween and a flange, and wherein a first bearing surface of larger external diameter of said bearing surfaces is situated on an entry side of the lower insert and is fixed in a corresponding receptacle in the receiving cycle part by being fixedly connected by gluing, and wherein an other bearing surface of said bearing surfaces allows reception of the upper insert, which is capable of being engaged by an other side of the receiving cycle part, and wherein the upper insert has a flange bearing on an opposite face of the receiving cycle part, a smooth outer bearing surface and internally, a female thread of certain diameter and a following bore of larger diameter capable of engaging on the other bearing surface of the lower insert.

7. The fastening insert as claimed in claim 4, wherein the lower insert is provided with a threaded bearing surface, which cooperates with a first threaded bearing surface established on the upper insert according to a first pitch with screw thread in one direction, whereas said upper insert has a second bearing surface according to a second pitch with thread directionally reversed relative to the first pitch, and wherein the lower insert or the upper insert has a peripheral zone of length capable of being glued for fastening and fixed connection to a body of the receiving cycle part, and wherein the hand tool has a sleeve with a threaded end capable of engaging in the upper insert on its second bearing surface to provide for the screwing of the upper insert and its unscrewing relative to the lower insert.

8. The fastening insert as claimed in claim 7, wherein the lower insert has its threaded bearing surface in the form of an outer periphery, said bearing surface being established on only a part of the length of the lower insert with a stop face and an adjacent peripheral bearing surface, with a flange, coming up to a front end of the lower insert and wherein the threaded bearing surface of the lower insert is established according to a screw pitch with thread in one direction, and wherein the upper insert is arranged at its front end with a bearing flange bearing on an opposite face of the receiving cycle part and a peripheral outer bearing surface of long length and constituting a gluing surface, and wherein, internally, the upper insert comprises two tapped or threaded bearing surfaces of different diameter, thus delimiting a stop shoulder, and wherein a first threaded or tapped bearing surface of larger internal diameter of said two bearing surfaces is located on a back of the upper insert and has a pitch such that fitting on the threaded bearing surface of the lower insert is possible, and wherein the second threaded or tapped bearing surface of the upper insert is located on a front side of the upper insert and has a screw pitch with reversed thread relative to the first threaded or tapped bearing surface, and wherein the second threaded or tapped bearing surface is capable of receiving, in rapid assembly and disassembly, the threaded end of the hand tool.

9. The fastening insert as claimed in claim 7, wherein the threaded bearing surface of the lower insert comprises an interior female thread according to a first screw pitch in one direction, and wherein this female thread is established from a rear face of the lower insert over a short length of the lower insert with a stop shoulder, and wherein, externally, the lower insert has a smooth peripheral face of length allowing gluing, and wherein the first threaded bearing surface is established on an outer periphery of the upper insert so as to cooperate with the female thread of the lower insert according to a corresponding thread pitch and a bearing flange, and wherein the second bearing surface is tapped internally according to another pitch and reverse-direction thread for reception of the tool.

10. The fastening insert of claim 1, wherein said receiving cycle part comprises a crank.
